(19) United States
(12) Patent Application Publication
(10) Pub. No.: US 2010/0122492 A1
(43) Pub. Date: May 20, 2010

(54) SHUTTER

(75) Inventors: Richard P. Morris, Oakville (CA); Kenneth H. Betts, Thornbury (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: C/S Construction Specialties Company, Mississauga (CA)

(21) Appl. No.: 12/616,832

(22) Filed: Nov. 12, 2009

Related U.S. Application Data
(60) Provisional application No. 61/193,295, filed on Nov. 14, 2008.

(51) Int. Cl. E06B 7/08

(52) U.S. Cl. 49/89.1; 49/92.1

(57) ABSTRACT

A shutter used, for example, as a sunshade has blades that are pivotally coupled to frame members of the shutter by respective pivot shafts that are split longitudinally into upper and lower halves. The pivot shaft halves can be adjusted radially with respect to one another to take up free movement that might otherwise allow the blades to vibrate when the shutter is in use.

### CROSS-REFERENCE TO RELATED APPLICATIONS

This application claims benefit from U.S. provisional application Ser. No. 61/193,295 filed Nov. 14, 2008 which is incorporated herein by reference in its entirety.

### FIELD OF THE INVENTION

This invention relates generally to shutters having movable blades or louvers.

### BACKGROUND OF THE INVENTION

The invention has been devised primarily in the context of window shutters that act as sunshades or other forms of weather barrier (e.g. hurricane shutters). At the same time, the invention may be applicable to shutter for other purposes, e.g. controlling air flow in ventilation systems.

Shutters that are designed as sunshades for building typically include a blade actuation system by which the angular positions of the blades can be adjusted to provide for controllable solar shading. In sophisticated systems, the shutter may be controlled automatically to provide variable shading in response to varying solar conditions during the day.

In commercial applications, the shutters typically are installed on the exterior of the building. As such, the shutters are exposed to wind and other weather conditions that can cause the blades to vibrate. This can lead to problems with noise, poor operation and possible failure.

An object of the present invention is to provide an improved shutter that addresses the problem of blade vibration.

### SUMMARY OF THE INVENTION

According to the invention there is provided a shutter comprising a plurality of frame members defining an opening, a plurality of blades extending across the opening between respective frame members that are parallel to one another and means for pivotally coupling each blade at each end to a respective one of the parallel frame members so that each blade is movable between an open position and a closed position with respect to the opening. The coupling means includes, at each end of each blade, a pivot shaft that is received in respective complimentary sleeves in the blade and adjacent frame member respectively. The shaft is split longitudinally into at least two co-extensive shaft elements that are radially movable with respect ton one another to vary the effective diameter of the shaft. Means is provided for effecting such radial movement so that the shaft can be expanded to take up clearance between the shaft and the respective sleeves.

In other words, the shaft can effectively be tightened into the respective sleeves to eliminate relative movement and thereby avoid or minimize vibration of the blade when the shutter is in use. The sleeve within the blade typically will be an integral part of the blade structure. For example, the blade may be an extrusion having a wall portion that is shaped to provide the required sleeve. At the other end of the shaft, the sleeve can simply be mounted to turn in the relevant frame member, or the sleeve can be part of an operating system for controlling movement of the blades.

Preferably, the shaft is split longitudinally into two shaft elements, each of generally semi-cylindrical shape. Inner faces of the respective shaft elements preferably are contoured in complimentary fashion to provide keyways that prevent lateral displacement of the shaft elements with respect to one another.

The shaft may also be “keyed” into the respective sleeves by appropriately contouring the external surface of the shaft and correspondingly contouring the internal surfaces of the sleeves. This will allow the shaft to slide in and out of the respective sleeves, which facilitates assembly of the shutter.

### BRIEF DESCRIPTION OF THE DRAWINGS

In order that the invention may be more clearly understood, reference will now be made to the accompanying drawings which illustrate a particular preferred embodiment of the invention by way of example, and in which:

FIG. 1 is a three-quarter perspective view from the front and above of a shutter in accordance with one embodiment of the invention;

FIG. 2 is a front elevational view corresponding to FIG. 1;

FIG. 3 is a detail perspective view of the part of FIG. 1 that is circled at A;

FIG. 4 is an exploded perspective view of one end of one of the blades of the shutter shown in the previous views;

FIG. 5 comprises perspective, plan and end elevational views of a typical blade, denoted respectively (a), (b) and (c); and,

FIG. 6 is an exploded perspective view from the rear in FIG. 1 showing one of the frame members of the shutter, and a blade actuating system incorporated within that frame member.

### DESCRIPTION OF PREFERRED EMBODIMENT

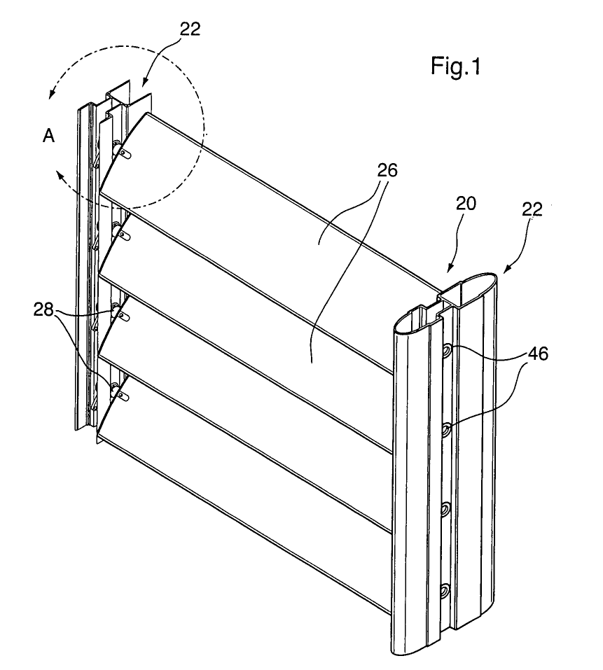

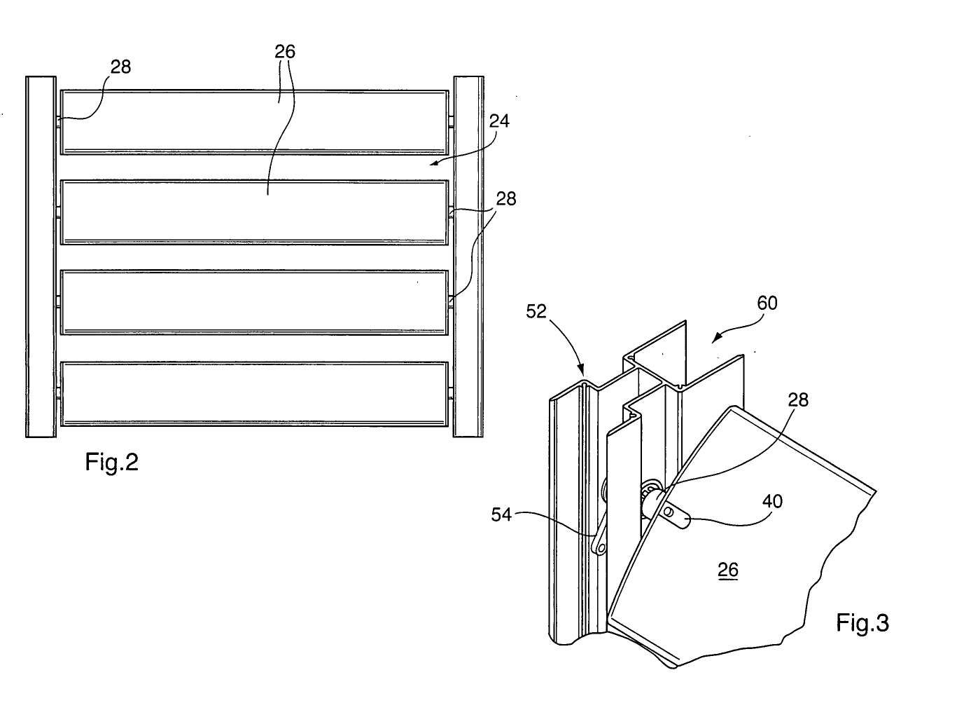

Referring first to FIGS. 1 and 2, a shutter that is designed to be used as a sunshade is shown by way of example and is generally designated by reference numeral 20. The shutter includes a pair of upright frame members or mullions 22 that define an opening 24. A plurality of blades 26 extend across the opening between the mullions and are movable between the closed positions in which they are shown in FIG. 2 and open positions in which the blades are “edge on” to any air flow through opening 24.

The particular shutter shown in the drawings is intended to be shipped in “knock-down” form and assembled on site at the exterior of a building. As such, the shutter does not have a complete frame as such, the opening 24 is defined by the two mullions 22. In other embodiments, a complete rectangular frame may be provided. The blades may extend horizontally as shown or vertically between the frame members.

At each end of each blade is a pivot shaft 28 by which the blade is mounted to the mullions 22.

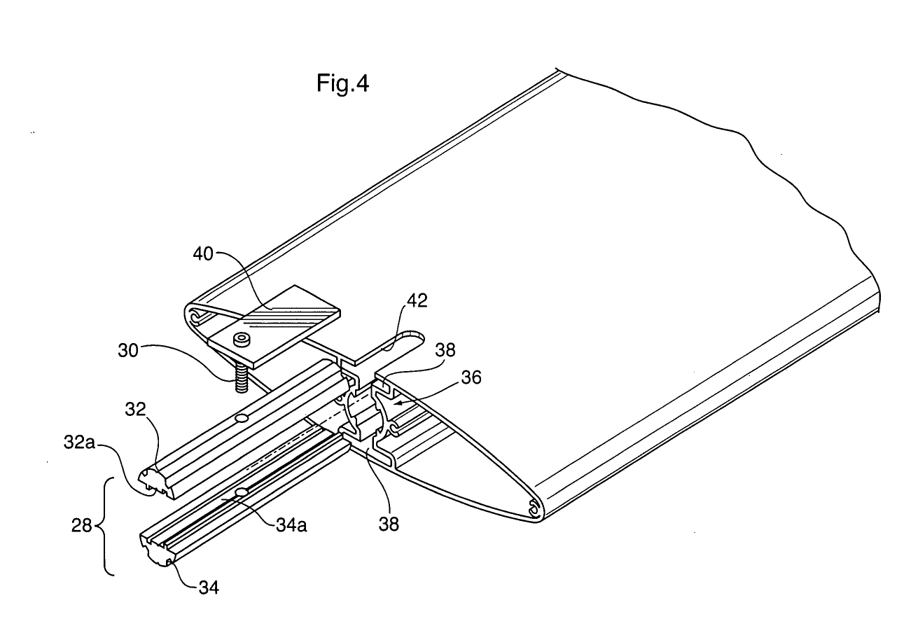

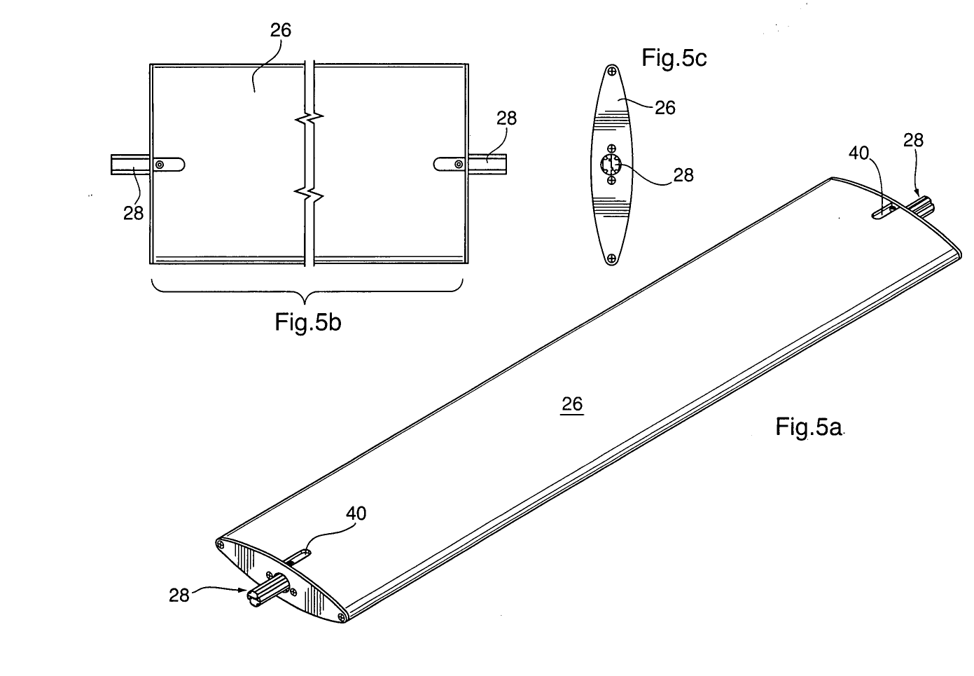

Referring now to FIG. 4, a typical one of the pivot shafts is shown in an exploded condition and separate from the blade itself. It will be seen that the shaft is split longitudinally into two co-extensive shaft elements. The elements are radially movable with respect to one another to vary the effective diameter of the shaft by means of an adjusting screw 30. In this way, the shaft can effectively be expanded radially to take up any clearance that might allow the blade to vibrate in use.

As seen in FIG. 4, shaft 28 includes upper and lower shaft halves each of generally semi-cylindrical shape. The halves are shown in exploded positions for clarity of illustration. In use, the parts fit together with their respective inner faces 32a, 34a in contact so that the shaft can fit into a complimentary sleeve 36 within the blade. A corresponding sleeve (not shown) is provided within the adjacent mullion 22 but is not shown in FIG. 4. It will be seen that the respective inner faces 32a, 34a are contoured in complimentary fashion to define keyways that prevent lateral displacement of the shaft halves with respect to one another, e.g. during assembly of the shutter. The external surfaces of the shaft halves are also longitudinally grooved and the internal surface of the sleeve 36 is provided with complimentary protrusions so that the shaft is also keyed to the sleeve and hence to the blade 26, i.e. can slide longitudinally with respect to the sleeve and blade but cannot be turned with respect to the sleeve and blade.

In the illustrated embodiment, the blades are extrusions and the walls of the extrusion are shaped to define the sleeve 36 (as well as other contour elements required in the blade). These include respective channels 38 above and below sleeve 36 for receiving a plate 40 that carries the shaft adjusting screw 30. Plate 40 is longitudinally slideable in channel 38 so that the adjusting screw 30 can move in and out with the pivot shaft 28. A slot 42 in the blade accommodates the screw and the plate 40 serves to cover the slot when the blade is in its assembled condition. Two channels 38 are provided so that plate 40 can be installed at either side of the blade, though normally there will be only one plate and one adjustment screw.

The adjustment screw 30 extends through a complimentarily screw-threaded opening 42 in the upper shaft half 32 and the distal end of the screw bears against a seat 44 on the lower shaft half 34. Thus, by turning the screw 30 in the appropriate direction, the two shaft halves 32, 34 are moved apart as the upper shaft half moves up the screw and the screw presses down on the lower shaft half 34. The opening 42 is disposed generally at the centre of the length of the pivot shaft so that the two shaft halves remain substantially parallel to one another as they are adjusted in the radial direction of the shaft.

The pivot shafts that are at the right hand ends of the respective blades as shown in FIGS. 1 and 2 are received in respective sleeves 46 that are mounted to turn freely in the mullion 22. As such, these sleeves will merely oscillate angularly back and forth as the blades move between their open and closed positions. Sleeves 46 have plain cylindrical exterior surfaces and contoured interior surfaces that are essentially the same as the interior surface of sleeve 36 shown in FIG. 4.

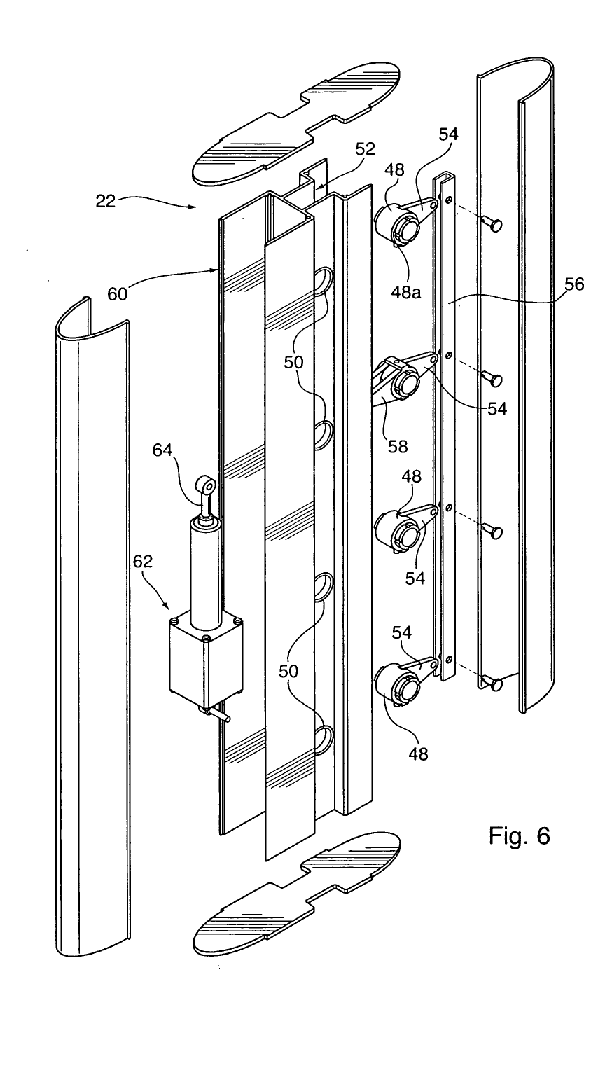

The mullion that is shown at the left hand side of the shutter in FIG. 1 supports respective sleeves that are similar to the sleeves 46 but that form part of a blade actuator system shown in an exploded configuration in FIG. 6. The sleeves are indicated at 48 and are mounted to turn in corresponding openings 50 in a vertical channel 52 of mullion 22. The sleeves have reduced diameter portions 48a at respectively opposite ends that are actually received in the openings 50 in channel 52 when the shutter is assembled. The pivot shafts 28 then extend into the respective sleeves through openings 50.

Each sleeve 48 has a radial arm 54 pivotally coupled to a vertical actuator rail 56 that effectively couples together all of the sleeves and, accordingly, all of the blades 26 of the shutter. One of the sleeves (in this case the second from the top) has a second radial arm 58 that is diametrally opposed to the first arm 54 and that extends through an opening (not shown) in mullion channel 52 and into a second channel 60 of the mullion. Channel 60 houses a blade actuator in the form of an electric servo motor and gearbox assembly 62. Assembly 62 includes a rod 64 that moves up and down when the motor is operated and which is pivotally coupled at its upper end to the sleeve arm 58 mentioned previously. Accordingly, the shutter blades 26 move together through the same angular amount upon operation of actuator assembly 62.

As mentioned previously, the sleeves 48 are internally profiled in the same way as the sleeves 36 so that the pivot shafts 28 are keyed to the respective sleeves and can move longitudinally with respect to the sleeve, but not radially. This feature allows the shutter to be assembled by first sliding the respective pivot shafts fully into the sleeves 36 in the blades (so that the pivot shafts are retracted), positioning the blades as required, and then extending the pivot shafts into the complimentary sleeves in the mullions of the shutter. Each shaft is then “snugged” into place by turning the relevant adjusting screw 30 to take up clearance between the shaft and the respective sleeves in the blade 26 and in the mullion 22. This effectively eliminates or at least minimizes vibration of the blade in use.

It will of course be appreciated that the preceding description relates to a particular preferred embodiment of the invention and that many modifications are possible, some of which have been indicated above, and others of which will be apparent to a person skilled in the art. Though the preferred embodiment involves the use of two semi-cylindrical shaft elements, it is to be understood that the two shaft elements need not be of the same cross-sectional shape and/or that more than two elements could be used, though probably at the cost of additional complexity. In a basic form of shutter, the shaft elements could even have plain exterior surfaces, i.e. not be keyed into the sleeves or to each other. Further, although the invention has been described in the context of an exterior sunshade for a building, the invention is not limited to this application.

1. A shutter comprising a plurality of frame members defining an opening, a plurality of blades extending across the opening between respective said frame members that are parallel to one another, and means pivotally coupling each blade at its ends to one of said parallel frame members so that the blade is movable between an open position and a closed position with respect to said opening, the coupling means comprising, at each end of each blade, a pivot shaft that is received in respective complimentary sleeves in the blade and in the adjacent frame member respectively, the shaft being split longitudinally into at least two co-extensive shaft elements that are radially movable with respect to one another to vary the effective diameter of the shaft, and means for effecting said radial movement so that the shaft can be expanded to take up clearance between the shaft and the respective sleeves.

2. A shutter as claimed in claim 1, wherein the two co-extensive shaft elements are each of semi-cylindrical shape.

3. A shutter as claimed in claim 2, wherein the two shaft elements meet at inner faces that are contoured in complimentary fashion to provide keyways preventing lateral displacement of the shaft elements with respect to one another.

4. A shutter as claimed in claim 1, wherein external surfaces of the shaft elements and internal surfaces of the sleeves are contoured to provide keyways that allow the assembled shaft to slide in and out of the respective sleeves, while preventing relative angular movement between the shaft and sleeves.

5. A shutter as claimed in claim 1, wherein the blade is an extrusion having a wall contoured to provide said complimentary sleeve at each end of the blade.

6. A shutter as claimed in claim 1, wherein said means for effecting radial movement of the shaft elements with respect to one another comprises an adjusting screw that extends through a complimentarily screw-threaded radial opening in one of said shaft elements and has an outer end that bears against the other shaft element, whereby the shaft elements are moved apart by turning the screw in the appropriate angular direction.

7. A shutter as claimed in claim 6, wherein the adjusting screw is carried by a plate that is slideably mounted in the blade for movement parallel to said pivot shaft.

8. A shutter as claimed in claim 1, wherein a blade actuator system is associated with one of said frame members and includes an actuator movable between first and second positions corresponding to said open and closed positions of the blades, and means coupling said actuator with the pivot shaft sleeves in the associated frame member and adapted to turn said sleeves together through the same angular amount as the actuator moves between its first and second positions.

9. A shutter as claimed in claim 8, wherein the coupling means includes a radially extending arm on each of said sleeves coupled to a common actuator rail, and a second radial arm on a selective one of said sleeves coupled to the actuator so that the second arm turns the associated sleeve in response to movement of the actuator and, in turn, transmits such movement to the other sleeves by way of said actuator rail.
